(19) United States
(12) Patent Application Publication
(10) Pub. No.: US 2008/0152091 A1
(43) Pub. Date: Jun. 26, 2008

(54) Priority-Based Call Routing

(75) Inventor: Veli-Pekka Kivimaki, Jarvenpaa (FI)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/616,129

(22) Filed: Dec. 26, 2006

(51) Int. Cl. H04M 11/04; H04M 7/00

(52) U.S. Cl. 379/45; 379/221.01

(57) ABSTRACT

The present invention provides methods, apparatuses, and computer media for re-routing outgoing calls from a communications terminal. A call routing module selects a set of re-routing plug-ins. One of plug-ins determines re-routing information for an outgoing call based on call information in accordance with a priority list. A priority order for offering a call event to a re-routing plug-in is determined from at least preference list. A preference list may be configured by a subscriber through a user interface. Also, preference lists and re-routing plug-ins may be downloaded over a communications channels. Another re-routing plug-in is offered a call event if a first re-routing plug-in is not able to re-route an outgoing call. One of a plurality of communications systems is selected for re-routing an outgoing call. A communications systems supporting a close-proximity technology may be selected when a communications terminal is sufficiently near the communications system.

### FIELD OF THE INVENTION

The present invention relates to call routing in a communications terminal such as a wireless terminal.

### BACKGROUND OF THE INVENTION

Traditional telephonic communications is based on local wire facilities (local lines) between a subscriber to a switching facility. In order to complete a telephonic connection between the subscriber and another subscriber, the switching facility (typically comprising a hierarchical structure of local and long distance switches) connects to the local line of the other subscriber. However, with the explosion of new technologies, telephonic communications may be supported by different communication domains. Consequently, a subscriber can select from different communication domains when calling another subscriber.

For example, proprietary systems offer corporations different methods for least-cost routing (LCR) of telephony calls, so that wireless subscribers may dial from one country to another by calling a gateway in the originating country. The gateway may perform toll-bypass by routing the call over a corporation's established IP (Internet Protocol) backbone to the target country. Moreover, with convergence devices the option of using VoIP (Voice over IP) over WLAN (Wireless Local Area Network) is rapidly becoming another possibility, along with proximity calling technologies, such as Bluetooth. Thus, there is a real market need for managing the most efficient and economic routing selection from numerous routing options.

### BRIEF SUMMARY OF THE INVENTION

An aspect of the present invention provides methods, apparatuses, and computer media for re-routing outgoing calls from a communications terminal.

With an aspect of the invention, a call routing module selects a set of re-routing plug-ins. One of plug-ins determines re-routing information for an outgoing call based on call information. The call event is presented to the plug-ins in accordance with a priority list. Re-routing may be based on a bearer type and an access type.

With another aspect of the invention, a priority order for offering a call event to a re-routing plug-in is determined from at least one preference list. A preference list may be configured by a subscriber through a user interface. Also, preference lists and re-routing plug-ins may be downloaded over a communications channels.

With another aspect of the invention, another re-routing plug-in is offered a call event if a first re-routing plug-in is not able to re-route an outgoing call.

With another aspect of the invention, one of a plurality of communications systems is selected for re-routing an outgoing call. A communications systems supporting a close-proximity technology may be selected when a communications terminal is sufficiently near the communications system.

### BRIEF DESCRIPTION OF THE DRAWINGS

A more complete understanding of the present invention may be acquired by referring to the following description in consideration of the accompanying drawings, in which like reference numbers indicate like features and wherein:

FIG. 1 shows a communications terminal interacting with a plurality of communications systems when routing calls in accordance with an embodiment of the invention.

FIG. 2 shows an architecture for routing calls from a communications terminal in accordance with an embodiment of the invention.

FIG. 3 shows call routing logic for a communications terminal in accordance with an embodiment of the invention.

FIG. 4 shows an architecture for a communications terminal in accordance an embodiment of the invention.

### DETAILED DESCRIPTION OF THE INVENTION

In the following description of the various embodiments, reference is made to the accompanying drawings which form a part hereof, and in which is shown by way of illustration various embodiments in which the invention may be practiced. It is to be understood that other embodiments may be utilized and structural and functional modifications may be made without departing from the scope of the present invention.

The following is separated by subheadings for the benefit of the reader. The subheadings include: Terms, Architecture of Platform, Exemplary Message Scenario, Process for Querying Metadata, and Apparatus for a User Device.

Terms

Plug-in—a hardware or software module (component) that adds a specific feature or service to a larger system in order to enhance the capability of the system. When implemented as a software module, an auxiliary program works with a major software package to enhance its capability. For example, plug-ins are widely used in image editing programs such as Photoshop to add a filter for some special effect. Plug-ins are added to Web browsers to enable them to support new types of content (audio, video, etc.).

Architecture for Call Routing with a Communications Terminal

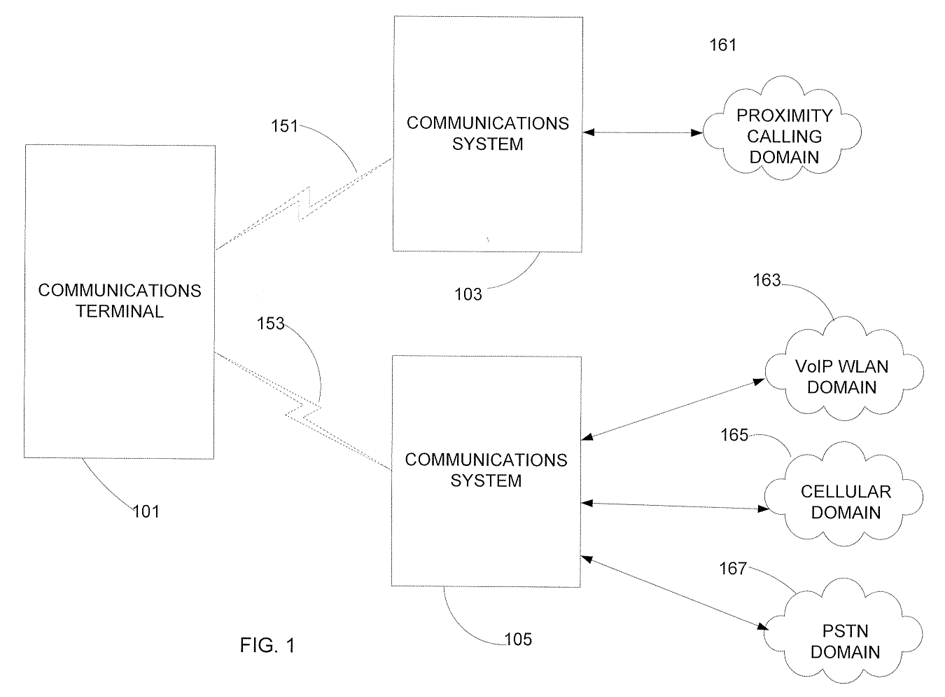

FIG. 1 shows communications terminal 101 interacting with a plurality of communications systems 103, 105 when routing calls in accordance with an embodiment of the invention. Communications terminal 101 may assume different forms, including a wireless terminal, a cable telephony device, or a wire-tethered telephone.

With an embodiment of the invention, communications terminal 101 interacts with other communications terminals through communications system 105 over communications channel 153. With an exemplary embodiment, communications system 105 comprises a cellular infrastructure that may interact with VoIP (Voice over IP) WLAN (Wireless Local Area Network) domain 163, cellular domain 165, and public switched telephone network (PSTN) domain 167. Communications system 105 may select one of the domains 163-167 for least-cost routing (LCR) in order to provide service for communications terminal 101 with the possible lowest cost for the outgoing call.

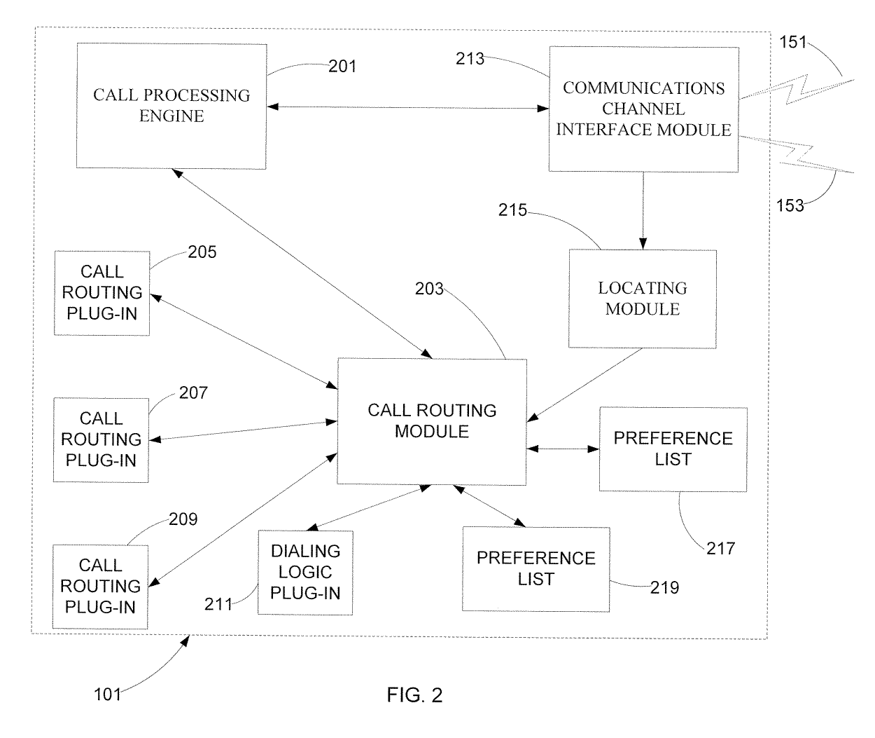

The outgoing call may be routed as dialed by the subscriber of communications terminal 101. However, communications terminal 101 (e.g., a mobile telephone) may re-route an outgoing call to a gateway in an originating country. The gateway may then route the outgoing call over an IP backbone to the designated country in order to perform toll-bypass for least-cost routing (LCR). When communications terminal 101 supports the convergence of services, VoIP (Voice over IP) over WLAN (Wireless Local Area Network) and proximity calling (e.g., Bluetooth) are additional ways to re-route the outgoing call. As will be discussed in FIG. 2, a centralized framework for managing and determining the most efficient and lowest-cost call routing options is provided to facilitate the selection from many possible call routing options.

Referring to FIG. 1, communications terminal 101 may re-route an outgoing call to domain 163, 165, or 167 through communications system 105 based on a bearer type and/or access type as contained in a request for placing an outgoing call. For example, with a WCDMA service model, service parameters may be defined that are the relevant parameters of bearer types used by the service in the uplink and downlink communication channels. Different service types may be included into one type if the service types use the same bearer for transmission. Bearer types include: circuit switched CS12.2K, CS64K, packet switched PS64K, PS128K and PS384K. Each bearer type includes these parameters: data bearing rate, transmitting power, E_{b}/N₀ and channel element (CE) resources. These parameters are only related to the network system and equipment, and the parameters are basically fixed in different network environments. The access type characterizes user data that is transported during a call. For example, user data may be transported with two-way communication, which includes conversational traffic and interactive traffic. Also, user data may be transported as one-way communication, e.g., streaming data. Furthermore, the media type may be specified, including audio, video, and multimedia.

With an embodiment of the invention, when communications terminal 101 is in close proximity to communications system 103, outgoing calls are re-routed to communications system 103 over communications channel 151. Embodiments of the invention support different types of close-proximity technology, including Bluetooth and ultra-wideband (UWB) technologies. As will be discussed, communications terminal 101 may determine its proximity to communications system 103 based upon the position (location) of communications terminal 101.

FIG. 2 shows an architecture for routing calls from communications terminal 101 in accordance with an embodiment of the invention. Call processing engine 201 provides the basic function for processing an outgoing call as requested by the subscriber. When call processing engine 201 receives a request for an outgoing call, call processing engine 201 informs call routing module 203 about outgoing call with the associated requested access type and bearer type.

When the subscriber wishes to place an outgoing (outbound) call, call routing module 203 reads preference list 217 and preference list 219 to determine priorities for different call access (dialling) methods, where each call access method corresponds to a plug-in. Embodiments of the invention may support one or more preference lists and may contain information about preferences, including:
user preferences/priorities,
provisioned preferences/priorities (e.g. corporate call routing rules), and
available access methods.

Preference list 217 may contain preferences that are based on a number of factors that include the destination of the outgoing call, position of communications terminal 101, requested bearer type, and requested access type. For example, for a two-way multimedia call requiring a packet switched 384K bearer channel, the subscriber may prefer that call routing plug-in 205 re-route the call. However, if call routing plug-in 205 is unable to re-route the call, then call routing plug-in 207 should re-route the call. Call routing by the re-routing plug-ins 205-209 re-routes the call for the most economical cost for the desired bearer type and access type.

With an exemplary embodiment, a preference list may indicate that VoIP over WLAN is preferred for all outgoing calls, followed by VoIP over WCDMA (GPRS data), and then followed by GSM, which is the last fallback with the least priority. Thus, whenever the user is within the coverage of a known WLAN network, or a connection can be tunneled using VPN technology to the corporate network over a hotspot-type WLAN environment, the call is completed over that bearer. However, if a plug-in determines a WLAN call cannot be completed, the next plug-in would be offered to route the call. In the exemplary embodiment the next plug-in is the WCDMA VoIP routing plug-in.

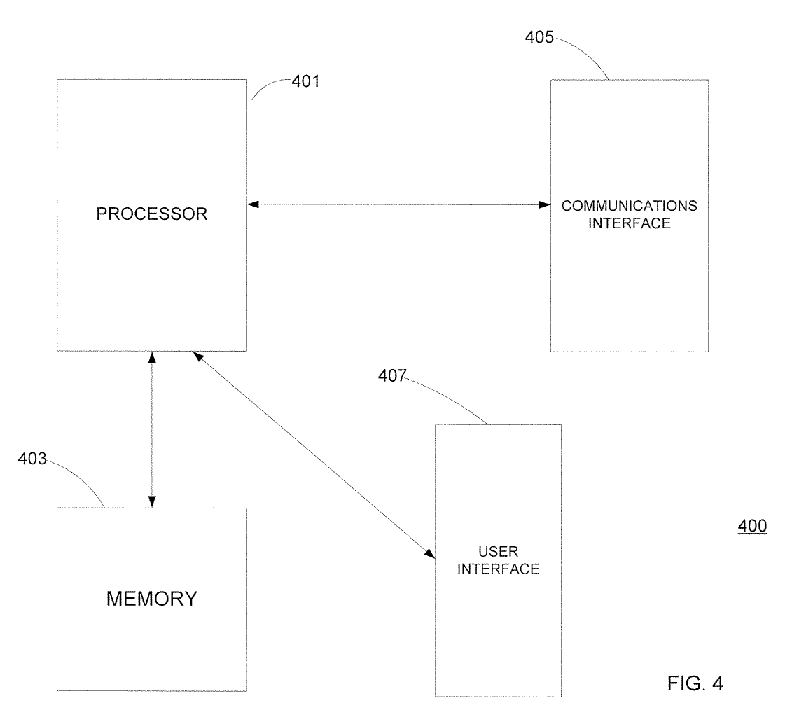

Preference lists 217 and 219 indicate routing method prioritization when end-user (subscriber) configuration (is allowed. For example, a subscriber may enter preference information though user interface 407 as shown in FIG. 4. Provisioning capabilities may be supported for obtaining preference lists and re-routing plug-ins through communications channel interface module 213 for obtaining corporate call routing preference tables and plug-ins into terminal 101. Call routing module 203 supports a framework to provide a plug-in interface for call routing methods and is capable of performing preference checking and prioritizing.

The different dialling methods are implemented as plug-ins (plug-ins 205-209) to a call routing framework (call routing module 203). Call routing module 203 checks installed plug-ins 205-209 in relation to the preference lists (e.g., preference list 217), and determines a priority order for the routing mechanisms. The call event is then offered to plug-ins 205-209 based on the determined priority order. Plug-ins 205-209 may further internally check whether they are able to re-route the call. If none of the call routing plug-ins 205-209 is able to offer a lesser cost route, the outgoing call is routed as dialled (e.g., as a regular GSM call).

The position (location) of communications terminal 101 is determined by locating module 215. Locating module 215 may determine the position of communications terminal 101 in a number of ways. For example, locating module 215 may monitor an overhead data from communications system 103 or 105 through communications channel interface module 213 to identify which communications systems can serve communications terminal 101. Also, locating module may incorporate a global positioning system (GPS) receiver.

Call routing module 203 may also support other types of plug-ins, e.g., dialling logic plug-in 211 that may enhance dialling. With an embodiment of the invention, plug-in 211 supports two-stage dialling logic.

With an embodiment of the invention, call routing module 203 may be implemented as a separate module from call processing engine 201. However, with other embodiments of the invention, call routing module 203 may be integrated with call processing engine 201.

Call Routing Logic

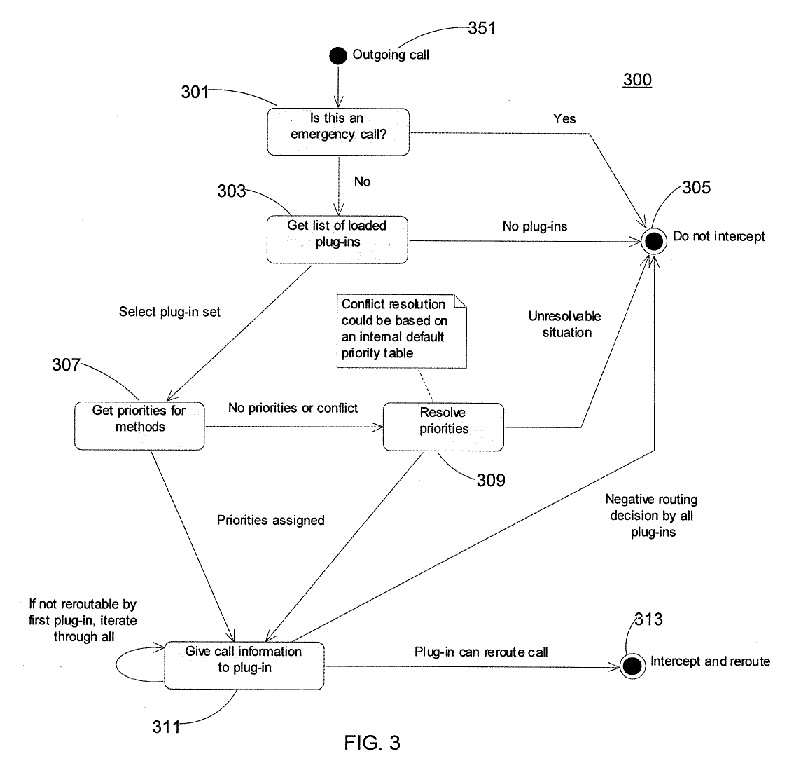

FIG. 3 shows call routing logic 300 for communications terminal 101 in accordance with an embodiment of the invention. In an embodiment of the invention, call routing logic 300 is implemented as part of call routing module 203 as shown in FIG. 2.

Step 301 determines whether outgoing call 351 is an emergency call. If so, outgoing call 351 is routed as dialed in step 305. Otherwise, calling routing module 203 obtains a list of loaded call routing plug-ins (corresponding to plugs-ins 205-209 as shown in FIG. 2) in step 303. Call routing module 203 selects a set of plug-ins from the loaded plug-ins and determines the priority order from preference lists 217-219 in step 307. If a priority order cannot be determined or if there is a conflict in the priority order, step 309 attempts to resolve the conflict. If step 309 cannot resolve the conflict or determine the priority order, outgoing call 351 is routed as dialed in step 305.

When a priority order has been determined, call information is provided to a first plug-in in accordance with the priority order in step 311. If the first plug-in cannot re-route outgoing call 351, the next plug-in (as ordered by the priority order) is presented the call information for re-routing. This step is reiterated until a plug-in can re-route outgoing call 351 or until it is determined that no plug-in is able to re-route the call. When one of the plug-ins can re-route the call, re-routing information, as provided by the plug-in, is used to re-route the call in step 313. If none of the plug-ins can re-route the call, outgoing call is routed as dialed in step 305.

When re-routing outgoing call 351, call processing module 301 includes re-routing information in a call origination message over a communications channel to communications system 103 or 105 to indicate how the call should be re-routed. For example, the re-routing information may include an access code with the dialed digits. With embodiments of the invention, re-routing information may be provided in different ways. For example with a circuit-switched network, the typical mechanism for signaling call origination to a server is DTMF. In a packet-switched domain, the call origination request may be encapsulated with some type of TCP/IP protocol means, e.g., using the SIP protocol. In this case, the message may indicate that the target system initiate a subsequent dialing procedure, either by completing the call directly or by initiating a call-back over the GSM network, if the active IP bearer is not fast enough to support VoIP.

Architecture of a Communications Terminal

FIG. 4 shows architecture 400 for a communications terminal 101 in accordance an embodiment of the invention. Processor 401 executes computer-executable instructions (corresponding to call processing engine 201 and call routing module 203) from memory 403. In addition, memory 403 may contain data structures such as preference lists 217 and 219 and plug-ins 205-211.

Processor 401 interacts with communications systems (e.g., communications systems 103 and 105) over a communications channel through communications interface 405 when routing an outgoing call.

User preferences (e.g., preference list 217 or 219) may be entered through user interface 407. Also, other preference lists (e.g., corporate call routing preference tables) and plug-ins may be downloaded over a communications channel through communications interface 405.

As can be appreciated by one skilled in the art, a computer system with an associated computer-readable medium containing instructions for controlling the computer system can be utilized to implement the exemplary embodiments that are disclosed herein. The computer system may include at least one computer such as a microprocessor, digital signal processor, and associated peripheral electronic circuitry.

While the invention has been described with respect to specific examples including presently preferred modes of carrying out the invention, those skilled in the art will appreciate that there are numerous variations, permutations and combinations of the above described systems, techniques and embodiments that fall within the spirit and scope of the invention as set forth in the appended claims.

I claim:

1. A method comprising:
(a) obtaining a request for an outgoing call to a selected designation;
(b) selecting a set of plug-ins, each plug-in providing a call routing method;
(c) determining a priority order from at least one preference list;
(d) offering a call event for the outgoing call to the set of plug-ins based on the priority order;
(e) when the outgoing call can be re-routed by one of the set of plug-ins, obtaining re-routing information from said one of the set of plug-ins; and
(f) re-routing the outgoing call to the selected designation in accordance with the re-routing information.

2. The method of claim 1, further comprising:
(g) when a first plug-in of the set of plug-ins cannot re-route the outgoing call, offering the call event to another plug-in of the set of plug-ins in accordance with the priority order.

3. The method of claim 1, further comprising:
(g) when no plug-in of the set of plug-ins cannot re-route the outgoing call, routing the outgoing call as dialed.

4. The method of claim 1, further comprising:
(g) when the outgoing call is identified as an emergency call, routing the outgoing call as dialed.

5. The method of claim 1, further comprising:
(g) when the priority order cannot be determined from the at least one preference list, resolving the priority order.

6. The method of claim 5, (g) comprising:
(g)(i) obtaining a default resolution from a data structure.

7. The method of claim 1, further comprising:
(g) when a conflict is detected in the priority order, resolving the priority order.

8. The method of claim 1, further comprising:
(g) when the priority order cannot be resolved, routing the outgoing call as dialed.

9. The method of claim 1, further comprising:
(g) configuring one of the at least one preference lists from a user input.

10. The method of claim 1, further comprising:
(g) downloading one of the at least one preference lists from preference data received over a communications channel.

11. The method of claim 1, (f) comprising:
(f)(i) selecting one of a plurality of communications systems based on the re-routing information; and
(f)(ii) re-routing the outgoing call to said one of the plurality of communications systems over an associated communications channel.

12. The method of claim 1, the re-routing information based a reduced cost associated with the outgoing call.

13. The method of claim 1, the request being indicative of a bearer type.

14. The method of claim 1, the request being indicative of an access type.

15. The method of claim 1, further comprising:
(g) determining position information that identifies a position of the communications terminal;
(h) providing the position information to said one of the set of plug-ins; and
(i) obtaining the re-routing information that is based on the position information.

16. An apparatus comprising:
a call processing engine configured to obtain a request for an outgoing call to a selected designation and to initiate the outgoing call; and
a call routing module configured to:
receive a request from the call processing engine for the outgoing call to the selected designation;
select a set of plug-ins, each plug-in providing a call routing method;
determine a priority order from at least one preference list;
offer a call event for the outgoing call to the set of plug-ins based on the priority order;
obtain re-routing information from said one of the set of plug-ins when the outgoing call can be re-routed by one of the set of plug-ins; and
instruct the call processing engine to initiate the outgoing call by re-routing the outgoing call to the selected designation in accordance with the re-routing information.

17. The apparatus of claim 16, further comprising:
a plurality of plug-ins,
wherein the call routing module is configured to select the set of plug-ins from the plurality of plug-ins.

18. The apparatus of claim 16, wherein the call routing module configured to select one of a plurality of communications systems when re-routing the outgoing call, the apparatus further comprising:
a communications channel interface module configured to interact with the selected communications system for re-routing the outgoing call.

19. The apparatus of claim 16, further comprising:
a user interface module configured to obtain user information for configuring one of the at least one preference lists.

20. The apparatus of claim 16, the call routing module configured to offer the call event to another plug-in of the set of plug-ins in accordance with the priority order when a first plug-in of the set of plug-ins cannot re-route the outgoing call.

21. A computer-readable medium having computer-executable instructions comprising:
(a) obtaining a request for an outgoing call to a selected designation;
(b) selecting a set of plug-ins, each plug-in providing a call routing method;
(c) determining a priority order from at least one preference list;
(d) offering a call event for the outgoing call to the set of plug-ins based on the priority order;
(e) when the outgoing call can be re-routed by one of the set of plug-ins, obtaining re-routing information from said one of the set of plug-ins; and
(f) re-routing the outgoing call to the selected designation in accordance with the re-routing information.

22. The computer-readable medium of claim 21, further comprising:
(g) when a first plug-in of the set of plug-ins cannot re-route the outgoing call, offering the call event to another plug-in of the set of plug-ins in accordance with the priority order.

23. The computer-readable medium of claim 21, further comprising:
(f)(i) selecting one of a plurality of communications systems based on the re-routing information; and
(f)(ii) re-routing the outgoing call to said one of the plurality of communications systems over an associated communications channel.

24. The computer-readable medium of claim 21, further comprising:
(g) when no plug-in of the set of plug-ins cannot re-route the outgoing call, routing the outgoing call as dialed.

25. An apparatus comprising:
(a) means for obtaining a request for an outgoing call to a selected designation;
(b) means for selecting a set of plug-ins, each plug-in providing a call routing method;
(c) means for determining a priority order from at least one preference list;
(d) means for offering a call event for the outgoing call to the set of plug-ins based on the priority order;
(e) means for obtaining re-routing information from said one of the set of plug-ins; and
(f) means for re-routing the outgoing call to the selected designation in accordance with the re-routing information.

26. The apparatus of claim 25, further comprising:
(g) means for offering the call event to another plug-in of the set of plug-ins in accordance with the priority order when a first plug-in of the set of plug-ins cannot re-route the outgoing call.

27. A method comprising:
(a) obtaining a request for an outgoing call to a selected designation;
(b) selecting a set of plug-ins, each plug-in providing a call routing method;
(c) determining a priority order from at least one preference list;
(d) offering a call event for the outgoing call to the set of plug-ins based on the priority order;
(e) determining re-routing information from call information for the outgoing call;
(f) when the outgoing call can be re-routed by one of the set of plug-ins, obtaining the re-routing information from said one of the set of plug-ins; and
(g) re-routing the outgoing call to the selected designation in accordance with the re-routing information.
